(19) United States
(12) Patent Application Publication
(10) Pub. No.: US 2013/0140083 A1
(43) Pub. Date: Jun. 6, 2013

(54) ADHESIVE COMPOSITION, FILM-LIKE ADHESIVE, ADHESIVE SHEET, CIRCUIT CONNECTION STRUCTURE, METHOD FOR CONNECTING CIRCUIT MEMBERS, USE OF ADHESIVE COMPOSITION, USE OF FILM-LIKE ADHESIVE AND USE OF ADHESIVE SHEET

(71) Applicant: HITACHI CHEMICAL COMPANY, LTD., Tokyo (JP)

(72) Inventors: Hiroyuki Izawa, Ibaraki (JP); Motohiro Arifuku, Ibaraki (JP); Shigeki Katogi, Ibaraki (JP); Hiroshi Yokota, Ibaraki (JP); Taizou Yamamura, Ibaraki (JP)

(73) Assignee: HITACHI CHEMICAL COMPANY, LTD., Tokyo (JP)

(21) Appl. No.: 13/623,289

(22) Filed: Sep. 20, 2012

Related U.S. Application Data
(60) Provisional application No. 61/536,677, filed on Sep. 20, 2011.

(30) Foreign Application Priority Data
Sep. 20, 2011 (JP) PCT/JP2011/071388

(51) Int. Cl. C09J 1/00; H01R 4/04

(52) U.S. Cl. CPC C09J 1/00; H01R 4/04
USPC 174/94 R; 156/182; 428/331; 252/183.13; 252/500; 106/287.1

(57) ABSTRACT

An adhesive composition for bonding a first circuit member including a first circuit electrode formed on a first circuit substrate and a second circuit member including a second circuit electrode formed on a second circuit substrate, the first circuit electrode and the second circuit electrode being electrically connected, wherein at least one substrate among the first circuit substrate and the second circuit substrate includes a thermoplastic resin having a glass transition temperature of not more than 200° C. The adhesive composition contains core-shell type silicon particles having a core layer and a shell layer provided for coating the core layer.

### BACKGROUND OF THE INVENTION

1. Technical Field

An exemplary embodiment of the present invention relate to an adhesive composition, a film-like adhesive, an adhesive sheet, a circuit connection structure, a method for connecting circuit members, a use of the adhesive composition, a use of the film-like adhesive and a use of the adhesive sheet.

2. Background Art

In the case of semiconductor devices or liquid crystal display devices, various adhesive compositions have been used to bond various members in a device. These various adhesive compositions have been used, for example, to connect a liquid crystal display device to a tape carrier package (TCP) or to a chip on film (COF), for connecting the TCP or the COF to a printed circuit board, for connecting a flexible printed circuit (FPC) to the printed circuit board, or for mounting a semiconductor device on a substrate.

Conventionally, in adhesive compositions for semiconductor devices or liquid crystal devices, a thermosetting resin including an epoxy resin exhibiting a high degree of adhesiveness and high degree of reliability has been used (for example, see Patent Literature 1). The constituent components of the thermosetting resin commonly include an epoxy resin, a curing agent having reactivity with the epoxy resin, such as a phenol resin, and a thermal latent catalyst for promoting the reaction of the epoxy resin with the curing agent. The thermal latent catalyst exhibits no reactivity at a storage temperature including room temperature, however, exhibits high reactivity upon being heated. In addition, the thermal latent catalyst is an important factor in determining a curing temperature and a curing rate. Various compounds have been used as the thermal latent catalyst in view of storage stability at room temperature and the curing rate thereof upon being heated. In a practical process, desired adhesiveness is obtainable under curing conditions of a temperature of 170° C. to 250° C. for 1 to 3 hours.

Recently, as semiconductor devices have become highly integrated and high definition liquid crystal displays have been realized, pitches between devices and wirings have been narrowed and thus, heating during the curing process may adversely affect surrounding members. Thus, an adhesive composition is required to be cured at a low temperature. In addition, in order to decrease manufacturing costs, it is necessary to be increase throughput. Thus, the adhesive composition is required to be cured in a relatively short period of time.

However, in the conventional thermosetting resin including the epoxy resin it is necessary to use the thermal latent catalyst having a low activating energy in order to accomplish curing at a low temperature in a relatively short period of time (low temperature fast curing properties). In this case, the storage stability of the adhesive composition at room temperature may be deteriorated.

Instead, a radical curable adhesive composition using a radical polymerizable compound such as a compound including methacrylate derivatives with a peroxide compound as a radical polymerization initiator, has attracted attention as an adhesive composition having low temperature fast curing properties (for example, see Patent Literature 2). According to radical curing, curing may be performed at a low temperature within a short period of time, because the reactivity of the reaction active species, i.e., the radical, may be excellent.

However, the adhesive composition using the radical curing results in a high degree of curing shrinkage while the curing process is conducted, and thus, the bonding strength of a bond is decreased when compared with the case in which the adhesive composition including the epoxy resin is used. Particularly, the bonding strength of a bond with an inorganic material or a metal tends to be deteriorated.

Further, when connecting semiconductor devices or liquid crystal display devices using a glass substrate, or the like, or a printed board using an FR4 material, or the like, to a flexible printed circuit (FPC) board using a polymer film such as a polyimide or a polyester film or the like as a base, a degree of internal stress, based on differences in thermal expansion rates, may be high. Thus, problems concerning the detaching of the adhesive composition or the deterioration of connection reliability are generated.

As methods of improving bonding strength, a method of using an adhesive composition typically represented by a silane coupling agent (for example, see Patent Literature 3), a method of imparting flexibility to and improving the bonding strength of a cured product by means of an ether bond (for example, see Patent Literature 4) and a method of improving bonding strength by dispersing stress absorbing particles made by adding rubber-based elastic materials to an adhesive composition (see Patent Literatures 5, 6, 7, etc.), etc. have been suggested.

### PRIOR ART LITERATURES

### Patent Literatures

[Patent Literature 1] Japanese Unexamined Patent Application Publication HEI No. 1-113480
[Patent Literature 2] International Publication No. 98/044067
[Patent Literature 3] Japanese Patent No. 3344886
[Patent Literature 4] Japanese Patent Publication No. 3503740
[Patent Literature 5] Japanese Patent Publication No. 3477367
[Patent Literature 6] International Publication No. 09/020,005
[Patent Literature 7] International Publication No. 09/051,067

### SUMMARY OF INVENTION

Recently, an application of circuit members including polyethylene terephthalate (PET), polycarbonate (PC), polyethylene naphthalate (PEN), a cycloolefin polymer (COP), or the like is under consideration in order to realize slimming, weight reduction, flexibility, and the like in a touch panel, electronic paper, or the like. However, when organic materials having a low degree of heat-resistance, such as PET, PC, PEN, COP, and the like are used, heating during curing may tend to adversely affect the organic materials and surrounding members.

Accordingly, the adhesive composition is required to be cured at an even lower temperature. In addition, since the surface of PET, PC, PEN, COP, or the like is smooth, adhesiveness is low due to a physical mooring effect (an anchoring effect).

Here, it is preferable to improve the bonding strength of the radical curing adhesive composition having the low temperature curing properties. However, the organic materials such as PET, PC, PEN, COP, and the like, thermoplastic resins, easily form a crystalline part through an interaction between molecules due to a benzene ring, or the like contained therein, and thus it may have difficulties in forming a covalent bond with a silane coupling agent. Thus, sufficient bonding strength may not be obtained when using the organic materials by the method disclosed in Patent Literature 3.

In addition, since the organic materials such as PET, PC, PEN, COP, and the like have a higher thermal expansion coefficient than glass substrate, their surface energy is also different. Accordingly, a sufficient degree of flexibility is required for the adhesive composition to improve wettability on an adherent and to decrease internal stress. However, a sufficient degree of flexibility may not be imparted by the method disclosed in Patent Literature 4 and thus, the bonding strength of a bond is required to be increased even further.

According to the method disclosed in Patent Literature 5, since the glass transition temperature of stress absorbing particles is high, around 80° C. to 120° C., a sufficient stress relieving effect may not be obtained. In addition, sufficient bonding strength or connection resistance after performing a test under high temperature and high humidity conditions may not be obtained. According to the method of dispersing stress absorbing particles as disclosed in Patent Literature 6, a sufficient bonding strength improving effect with regard to forming bonds with the organic materials such as PET, PC, PEN, COP, COP, and the like may not be obtained. In addition, according to the methods disclosed in Patent Literatures 5, 6 and 7, an epoxy resin is used as a curing component in an adhesive composition. Thus, heating at a relatively high temperature is required in order to obtain a sufficient degree of adhesiveness, and an adverse effect on the organic materials such as PET, PC, PEN, COP, and the like may occur.

An object of the present invention is to provide an adhesive composition providing an excellent bonding strength with respect to organic materials having low heat-resistance such as polyethylene terephthalate (PET), polycarbonate (PC), polyethylene naphthalate (PEN), a cycloolefin polymer (COP), and the like, even when cured at a low temperature, and retaining a stable performance (bonding strength or connection resistance) after conducting a reliability test (a test conducted under conditions of high temperature and high humidity) for a long time, a film-like adhesive, an adhesive sheet, a circuit connection structure, a method for connecting circuit members, a use of the adhesive composition, a use of the film-like adhesive and a use of the adhesive sheet using the same.

In order to solve the above problems, the present inventors found that a low bonding strength between the organic materials such as polyethylene terephthalate (PET), polycarbonate (PC), polyethylene naphthalate (PEN), a cycloolefin polymer (COP), and the like, thermoplastic resins having low heat-resistance, with a semiconductor device or a liquid crystal display device, is caused by insufficient relief of an internal stress. In order to solve this problem, the present inventors undertook further research and found that an excellent bonding strength may be obtained and a stable performance (bonding strength or connection resistance) may be retained after conducting a reliability test (under conditions of high temperature and high humidity) for a long time by using silicon particles having a specific structure, to complete the present invention.

The present invention provides an adhesive composition for bonding a first circuit member including a first circuit electrode formed on a first circuit substrate and a second circuit member including a second circuit electrode formed on a second circuit substrate to electrically connect the first circuit electrode and the second circuit electrode, in which at least one substrate among the first circuit substrate and the second circuit substrate includes a thermoplastic resin having a glass transition temperature of not more than 200° C. The adhesive composition contains core-shell type silicon particles having a core layer and a shell layer provided for coating the core layer.

Since the adhesive composition includes the silicon particles having the specific structure, interactions between silicon particles may be relieved and structural viscosity (non-Newtonian viscosity) may be decreased. Thus, the dispersibility of the silicon particles into the resin may be considered to be improved to effectively and sufficiently relieve internal stress. Accordingly, the bonding strength of a bond to a base including thermoplastic resins having a glass transition temperature not less than 200° C. (for example, PET, PC, PEN, COP, and the like) may be improved and the bonding strength of a bond between circuit members may be improved. In addition, a stable performance (bonding strength or connection resistance) may be retained after conducting a reliability test for a long time.

In the specification, ‘a substrate including a thermoplastic resin having a glass transition temperature of not more than 200° C.’ corresponds to a substrate including a thermoplastic resin having a glass transition temperature of not more than 200° C., described in a Polymer Handbook (Polymer society section: Polymer data handbook, Base section, p. 525, Baifukan (1986)), etc. Here, the thermoplastic resin refers to a resin having thermoplastic properties which commonly does not include a cross-liked structure, however, may include some cross-linked structures only when having the thermoplastic properties. The glass transition temperature of the thermoplastic resin may be obtained by a measuring method to be described later.

The present invention provides an adhesive composition for bonding a first circuit member including a first circuit electrode formed on a first circuit substrate and a second circuit member including a second circuit electrode formed on a second circuit substrate to electrically connect the first circuit electrode and the second circuit electrode, in which at least one substrate among the first circuit substrate and the second circuit substrate includes at least one selected from the group consisting of polyethylene terephthalate, polycarbonate, polyethylene naphthalate and a cycloolefin polymer. The adhesive composition contains core-shell type silicon particles having a core layer and a shell layer provided for coating the core layer.

Since the adhesive composition includes the silicon particles having the specific structure, the interactions between silicon particles may be relieved and a structural viscosity (non-Newtonian viscosity) may be decreased. Thus, the dispersibility of the silicon particles into the resin may be considered to be improved to effectively and sufficiently relieve the internal stress. Accordingly, the bonding strength of a bond to a substrate including at least one selected from the group consisting of polyethylene terephthalate, polycarbonate, polyethylene naphthalate and a cycloolefin polymer may be improved, and the bonding strength of a bond between circuit members may be improved. In addition, a stable performance (bonding strength or connection resistance) may be retained after conducting a reliability test for a long time.

The preferred glass transition temperature of the core layer of the silicon particles is −130° C. to −20° C., is more preferably −125° C. to −40° C., and is particularly preferably −120° C. to −50° C. Accordingly, the internal stress may be sufficiently relieved and the bonding strength of a bond between circuit members may be improved. In addition, stable performance may be retained even after conducting a reliability test for a long time. When the glass transition temperature is greater than −20° C., internal stress may not be sufficiently relived and a sufficient bonding strength improving effect may not be obtained. When the glass transition temperature is less than −130° C., a sufficient coagulation force may not be obtainable and bonding strength may be decreased.

The adhesive composition in accordance with the present invention may preferably include a radical polymerizable compound. Accordingly, bonding by a low temperature curing becomes possible.

Preferably, the adhesive composition further includes conductive particles. By including the conductive particles, the adhesive composition may be provided with good conductivity or anisotropic conductivity and may be even more appropriately used for forming bonds between circuit members having a circuit electrode (connection terminal). In addition, a connection resistance may be decreased through an electrical connection between the circuit members by using the adhesive composition including the conductive particles.

The present invention provides a film-like adhesive obtained by forming the adhesive composition as a film. Further, the present invention provides an adhesive sheet including a base and an adhesive layer consisting of the film-like adhesive formed on the base.

The present invention provides a circuit connection structure including a first circuit member including a first circuit electrode formed on a first circuit substrate, a second circuit member including a second circuit electrode formed on a second circuit substrate and a connecting part interposed between a surface of the first circuit member with the first circuit electrode formed thereon and a surface of the second circuit member with the second circuit electrode thereon, and electrically connecting the first circuit electrode with the second circuit electrode to electrically connect the first circuit electrode with the second circuit electrode, in which at least one substrate among the first circuit substrate and the second circuit substrate includes a thermoplastic resin having a glass transition temperature of not more than 200° C. The connecting part comprises a cured product of the adhesive composition in accordance with the present invention.

In the circuit connection structure in accordance with exemplary embodiments, the connecting part comprises the cured product of the adhesive composition in accordance with the present invention. Thus, excellent bonding strength and stable performance (bonding strength or connection resistance) may be obtained after conducting a reliability test for a long time, even when using a substrate including the thermoplastic resin having the glass transition temperature of not less than 200° C.

The thermoplastic resin preferably includes at least one selected from the group consisting of polyethylene terephthalate, polycarbonate, polyethylene naphthalate and a cycloolefin polymer. Accordingly, the wettability and the bonding strength of circuit substrates and the adhesive composition may be improved and excellent connection reliability may be obtainable.

Preferably, one circuit substrate among the first circuit substrate and the second circuit substrate includes at least one selected from the group consisting of polyethylene terephthalate, polycarbonate, polyethylene naphthalate and a cycloolefin polymer, and the other circuit substrate includes at least one selected from the group consisting of a polyimide resin, polyethylene terephthalate, polycarbonate, polyethylene naphthalate and a cycloolefin polymer. Accordingly, the wettability and the bonding strength of circuit substrates and the adhesive composition may be improved and excellent connection reliability may be obtained.

The present invention provides a circuit connection structure including a first circuit member including a first circuit electrode formed on a first circuit substrate, a second circuit member including a second circuit electrode formed on a second circuit substrate and a connecting part interposed between a surface of the first circuit member with the first circuit electrode formed thereon and a surface of the second circuit member with the second circuit electrode thereon, and electrically connecting the first circuit electrode with the second circuit electrode, in which at least one substrate among the first circuit substrate and the second circuit substrate includes at least one selected from the group consisting of polyethylene terephthalate, polycarbonate, polyethylene naphthalate and a cycloolefin polymer. The connecting part comprises a cured product of the adhesive composition in accordance with the present invention.

In the circuit connection structure, the connecting part comprises the cured product of the adhesive composition in accordance with the present invention. Thus, an excellent bonding strength and a stable performance (bonding strength or connection resistance) after conducting a reliability test for a long time may be obtained even when using a substrate including at least one selected from the group consisting of polyethylene terephthalate, polycarbonate, polyethylene naphthalate and a cycloolefin polymer.

Preferably, one circuit substrate among the first circuit substrate and the second circuit substrate includes at least one selected from the group consisting of polyethylene terephthalate, polycarbonate, polyethylene naphthalate and a cycloolefin polymer, and the other circuit substrate includes at least one selected from the group consisting of a polyimide resin, polyethylene terephthalate, polycarbonate, polyethylene naphthalate and a cycloolefin polymer. Accordingly, the wettability and the bonding strength of circuit substrates and the adhesive composition may be improved and excellent connection reliability may be obtained.

The present invention provides a method for connecting circuit members for connecting a first circuit member including a first circuit electrode formed on a first circuit substrate and a second circuit member including a second circuit electrode formed on a second circuit substrate by interposing the adhesive composition in accordance with the present invention and curing to electrically connect the first circuit electrode and the second circuit electrode, and bond the first circuit member and the second circuit member, in which at least one substrate among the first circuit substrate and the second circuit substrate includes a thermoplastic resin having a glass transition temperature of not more than 200° C.

According to the method for connecting circuit members of the present invention, an excellent bonding strength and a stable performance (bonding strength or connection resistance) after conducting a reliability test for a long time may be obtained even when applying a low temperature curing appropriate for a substrate including the thermoplastic resin having the glass transition temperature not less than 200° C.

Also, the present invention provides a method for connecting circuit members for connecting a first circuit member including a first circuit electrode formed on a first circuit substrate and a second circuit member including a second circuit electrode formed on a second circuit substrate by interposing the adhesive composition in accordance with the present invention and curing to electrically connect the first circuit electrode and the second circuit electrode, and bond the first circuit member and the second circuit member, in which at least one substrate among the first circuit substrate and the second circuit substrate includes at least one selected from the group consisting of polyethylene terephthalate, polycarbonate, polyethylene naphthalate and a cycloolefin polymer.

According to the method for connecting circuit members, an excellent bonding strength and a stable performance (bonding strength or connection resistance) after conducting a reliability test for a long time may be obtained even when applying an appropriate low temperature curing with respect to a substrate including at least one selected from the group consisting of polyethylene terephthalate, polycarbonate, polyethylene naphthalate and a cycloolefin polymer.

The present invention provides a use of the adhesive composition of the present invention for bonding a first circuit member including a first circuit electrode formed on a first circuit substrate and a second circuit member including a second circuit electrode formed on a second circuit substrate so as to electrically connect the first circuit electrode and the second circuit electrode, in which at least one substrate among the first circuit substrate and the second circuit substrate includes a thermoplastic resin having a glass transition temperature of not more than 200° C.

Also, the present invention provides a use of the adhesive composition of the present invention for bonding a first circuit member including a first circuit electrode formed on a first circuit substrate and a second circuit member including a second circuit electrode formed on a second circuit substrate so as to electrically connect the first circuit electrode and the second circuit electrode, in which at least one substrate among the first circuit substrate and the second circuit substrate includes at least one selected from the group consisting of polyethylene terephthalate, polycarbonate, polyethylene naphthalate and a cycloolefin polymer.

The present invention provides a use of the film-like adhesive of the present invention for bonding a first circuit member including a first circuit electrode formed on a first circuit substrate and a second circuit member including a second circuit electrode formed on a second circuit substrate so as to electrically connect the first circuit electrode and the second circuit electrode, in which at least one substrate among the first circuit substrate and the second circuit substrate includes a thermoplastic resin having a glass transition temperature of not more than 200° C.

Also, the present invention provides a use of the film-like adhesive of the present invention for bonding a first circuit member including a first circuit electrode formed on a first circuit substrate and a second circuit member including a second circuit electrode formed on a second circuit substrate so as to electrically connect the first circuit electrode and the second circuit electrode, in which at least one substrate among the first circuit substrate and the second circuit substrate includes at least one selected from the group consisting of polyethylene terephthalate, polycarbonate, polyethylene naphthalate and a cycloolefin polymer.

The present invention provides a use of the adhesive sheet of the present invention for bonding a first circuit member including a first circuit electrode formed on a first circuit substrate and a second circuit member including a second circuit electrode formed on a second circuit substrate so as to electrically connect the first circuit electrode and the second circuit electrode, in which at least one substrate among the first circuit substrate and the second circuit substrate includes a thermoplastic resin having a glass transition temperature of not more than 200° C.

Also, the present invention provides a use of the adhesive sheet of the present invention for bonding a first circuit member including a first circuit electrode formed on a first circuit substrate and a second circuit member including a second circuit electrode formed on a second circuit substrate so as to electrically connect the first circuit electrode and the second circuit electrode, in which at least one substrate among the first circuit substrate and the second circuit substrate includes at least one selected from the group consisting of polyethylene terephthalate, polycarbonate, polyethylene naphthalate and a cycloolefin polymer.

According to the present invention, an adhesive composition providing an excellent bonding strength with respect to organic materials having low heat-resistance such as polyethylene terephthalate (PET), polycarbonate (PC), polyethylene naphthalate (PEN), a cycloolefin polymer (COP), etc. even when cured at a low temperature, and retaining a stable performance (bonding strength or connection resistance) after conducting a reliability test (test at a high temperature and high humidity) for a long time, a film-like adhesive, an adhesive sheet, a circuit connection structure, a method for connecting circuit members, a use of the adhesive composition, a use of the film-like adhesive and a use of the adhesive sheet using the same, are provided.

### BRIEF DESCRIPTION OF DRAWINGS

FIG. 1 is a cross-sectional view of an adhesive sheet in accordance with an exemplary embodiment.

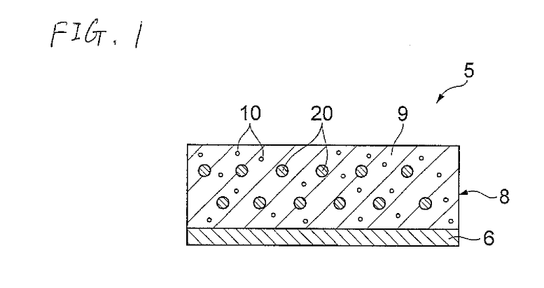

FIG. 2 is a cross-sectional view of a silicon particle in accordance with an exemplary embodiment.

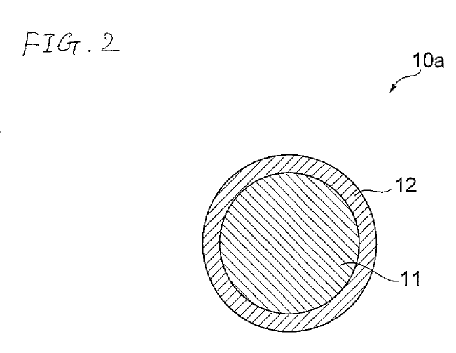

FIG. 3 is a cross-sectional view of a circuit connection structure in accordance with an exemplary embodiment.

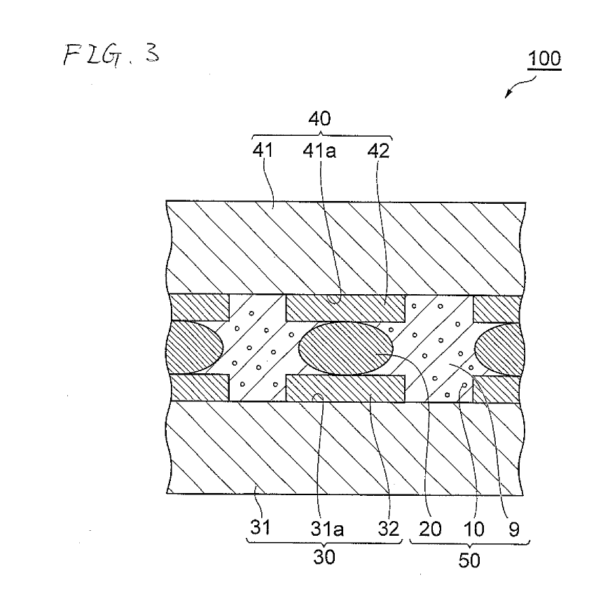

### DESCRIPTION OF PREFERRED EMBODIMENTS

Hereinafter, preferred embodiments on the present invention will be described in detail. However, the present invention should not be construed as limited to the exemplary embodiments set forth herein.

In the specification, ‘(meth)acrylic acid’ represents acrylic acid or corresponding methacrylic acid, ‘(meth)acrylate’ represents acrylate or corresponding methacrylate, and ‘(meth)acryloyl group’ represents an acryloyl group or a corresponding methacryloyl group.

‘The glass transition temperature (Tg)’ of a thermoplastic resin or a circuit substrate represents a tan δ peak temperature value measured under conditions of an increasing temperature rate of 5° C./min, a frequency of 10 Hz, and a measuring temperature of −150° C. to 300° C., by means of a viscoelastic analyzer ‘RSA-3’ (trade name) manufactured by TA Instrument Co. In order to measure the glass transition temperature of the circuit substrate when a base layer such as a glass layer, a hard coating layer such as an acryl resin layer, a gas barrier layer, etc. are formed on a thermoplastic resin substrate, the glass transition temperature of the circuit substrate including all the layers is measured.

‘The glass transition temperature (Tg)’ of particles represents a tan δ peak temperature value of a film produced by dispersing particles within a thermoplastic resin with a known Tg measured under conditions of an increasing rate of 5° C./min, a frequency of 10 Hz, and a measuring temperature of −150° C. to 300° C., by means of a viscoelastic analyzer ‘RSA-3’ (trade name) manufactured by TA Instrument Co.

‘The mean diameter’ of the particles represents a mean particle diameter (Z-average value) measured after diluting the particles by 0.1 wt % (% by weight) in methyl ethyl ketone by using Zetasizer Nano-S (manufactured by Malvern Instruments Ltd., trade name). For the particles having a large diameter, unmeasurable by means of the apparatus, a mean diameter measured by using a Shimazu laser diffraction type particle size distribution measuring apparatus, SALD-2200 (manufactured by Shimazu Co., Ltd., trade name) may be used.

The adhesive composition in accordance with exemplary embodiments is characterized by including silicon particles having a core-shell structure. The core-shell structure may have a structure including a core layer and a shell layer provided for coating the core layer. The shell layer may be a surface layer (shell layer) having a high glass transition temperature or elasticity due to the glass transition temperature or elasticity of the surface portion of a core material (core layer), or may be a graft layer (shell layer) formed on the outer portion of the core material (core layer). The core-shell structure may be formed by using silicon particles including the core layer and the shell layer having the same or different components. Particularly, core-shell type silicon particles obtained by adding an alkaline material or an aqueous alkaline solution along with organo trialkoxysilane into a water dispersion of silicon rubber spherical particles, hydrolyzing and condensing (for example, see Japanese Patent No. 2832143), and core-shell type silicon particles disclosed in the pamphlet of International publication No. 2009/051067, may be used. In addition, silicon particles including functional groups such as hydroxyl, epoxy, ketimine, carboxyl, mercapto, and the like at the terminal of the molecule or at the side chain in the molecule may be used. These silicon particles are preferable since the dispersibility of these silicon particles in film forming components or radical polymerizing materials may be improved. Further, forming a clear boundary line between the core layer and the shell layer is not necessary.

In view of a stress relieving effect, silicon, or silicon rubber, may be preferable for the core layer constituting the core-shell type silicon particles, and the same polymer or a different polymer may be used for the core layer and the shell layer. Preferably, physical properties (glass transition temperature, elasticity, and the like) of the shell layer are higher than those of the core layer. In this case, the structure and the shape of the core layer may be stabilized and the performance thereof may be effectively illustrated. Particularly, when the silicon, or the silicon rubber, is used as the core layer, the silicon, or the silicon rubber expands by the constituting materials such as a solvent or an adhesive composition, and the particles may easily adhere to form an aggregated structure. Through forming the shell layer, the formation of the aggregated structure may be suppressed.

The glass transition temperature of the core layer of the silicon particles is preferably −130° C. to −20° C., is more preferably −125° C. to −40° C., and is particularly preferably −120° C. to −50° C. The silicon particles may sufficiently relieve the internal stress of the adhesive composition.

In view of the relief of the internal stress of the adhesive composition, the weight average molecular weight of the silicon particles is preferably not more than 1,500,000, is more preferably 1,500,000 to 500,000, and is particularly preferably 1,400,000 to 800,000.

The weight average molecular weight in exemplary embodiments may be measured by Gel Permeation Chromatography (GPC) analysis under the following conditions, and may be obtained through a conversion using a standard polystyrene gauging line. The GPC condition is as follows.

Apparatus: Hitachi L-6000 type (manufactured by Hitachi Co., Ltd., trade name)

Detector: L-3300RI (manufactured by Hitachi Co., Ltd., trade name)

Column: Gelpack GL-R420+Gelpack GL-R430+Gelpack GL-R440 (three in total) (manufactured by Hitachi Chemical Co., Ltd., trade name)

Eluent: tetrahydrofurane

Measuring Temperature: 40° C.

Flow rate: 1.75 ml/min

The shell layer in the core-shell silicon particles preferably includes a cross-linked structure for attaining the structure stabilization, the shape retaining and the high performance of the core layer, and more preferably the shell layer includes the cross-linked structure having a three-dimensional network structure. More preferably, the shell layer may include an organic compound such as a polymethylmethacrylate copolymer, or the like, and an inorganic compound such as silicon, silica, silsesquioxane, or the like. In this case, the effect of relieving internal stress is effectively illustrated due to silicon.

The structure of the silicon particles, the core-shell silicon particles may be confirmed by observing the surface of the cross-section of the core-shell silicon particles and analyzing surface components. Particularly, the structural analysis may be conducted by means of a transmission electron microscope (TEM) using the following condition.

Resin mold: Epoxy resin (manufactured by Refinetech Co., Ltd., Epomount base and curing agent)

Heavy metal dying: 2 wt % aqueous solution of osmium tetraoxide (OsO₄) was prepared, and a bulk dying of the molded sample was conducted for 24 hours in the solution.

Pre-treatment: The sample was pre-treated using a diamond knife with a blade speed of 0.6 mm/sec while cooling to −120° C. using Cryo Ultramicrotome to form a thin film.

TEM observation: The kind and constitution of the core layer and the shell layer were confirmed from an image or EDX mapping by using a STEM/EDX apparatus; HD-270 manufactured by Hitachi Hitechnologies Co.

As another method, the structural analysis was conducted by using an atomic force microscope (AFM) according to the following condition.

Resin mold: Epoxy resin (manufactured by Refinetech Co., Ltd., Epomount base and curing agent)

Pre-treatment: The sample was pre-treated using a diamond knife with a blade speed of 0.6 mm/sec while cooling to −120° C. using Cryo Ultramicrotome to form a thin film.

Observation: The cross-section was observed by using an AFM manufactured by SII•Nanotechnology Co., and the shape mode and phase mode were measured in a DFM mode. The core-shell structure was confirmed in the phase mode.

The mean diameter of the silicon particles is preferably 0.05 μm to 25 μm, is more preferably 0.1 μm to 20 μm, and is particularly preferably 0.6 μm to 10 μm. By using the silicon particles within the mean diameter range, the accomplishment of both the fluidity and the internal stress relief of the adhesive composition may become advantageous.

The mixing amount of the silicon particles based on the amount of the adhesive components (adhesive composition excluding conductive particles) is preferably 1 wt % to 50 wt %, is more preferably 3 wt % to 30 wt %, and is particularly preferably 5 wt % to 30 wt %. Within the mixing amount range of the silicon particles, sufficient internal stress relief, flexibility (elasticity, tensile strength) and bonding strength of the adhesive composition may be attained.

One kind or two or more kinds of the core-shell silicon particles may be used. In addition, other silicon particles may be used in combination in so far as the effect of the present invention is not deteriorated.

In view of dispersibility and internal stress relief, the weight average molecular weight of the silicon particles is preferably not more than 1,500,000, more preferably in a range of 1,500,000 to 500,000, particularly preferably in a range of 1,400,000 to 800,000. In addition, other silicon particles preferably have a three-dimensional cross-linked structure. The terms ‘having the three-dimensional cross-linked structure’ mean that polymer rings have a three-dimensional network structure. The silicon particles having the three-dimensional cross-linked structure have a high degree of dispersibility in a resin and even better stress relieving properties after curing. Since the silicon particles having the weight average molecular weight of not less than 1,000,000, and/or the three-dimensional cross-linked structure have low dissolving properties in a polymer such as a thermoplastic resin, a monomer, a solvent, or the like, the dispersibility and the stress relieving effect may be remarkably increased.

As for other silicon particles, particles of a polyorganosilsesquioxane resin having rubber elasticity may be illustrated, and spherical and indeterminate silicon particles may be used. Particularly, silicon particles prepared by the reaction of organopolysiloxane including at least two vinyl groups, organohydrodienpolysiloxane including at least two hydrogen atoms combined to a silicon atom, and a platinum-based catalyst (for example, see Japanese Unexamined Patent Application Publication SHO No. 62-257939), silicon particles prepared by using organopolysiloxane having an alkenyl group, organopolysiloxane having a hydroxyl group and a platinum-based catalyst (for example, see Japanese Unexamined Patent Application Publication SHO No. 63-77942), silicon particles prepared by diorganosiloxane, monoorganosilsesquioxane, triorganosiloxane and a platinum-based catalyst (for example, see Japanese Unexamined Patent Application Publication SHO No. 62-270660), silicon particles prepared by dropping a water/alcohol solution of methylsilanetriol and/or a partial condensate thereof into an aqueous alkaline solution and polycondensating (for example, see Japanese Patent No. 3970453), etc. may be used. In addition, to improve dispersibility or adherence to a substrate, epoxy compound added or copolymerized silicon particles (for example, see Japanese Unexamined Patent Application Publication HEI No. 3-167228), acrylic acid ester compound added or copolymerized silicon particles, or the like may be used.

The radical polymerizable compound included in the adhesive composition refers to a compound inducing radical polymerization by an action of a radical polymerization initiator. The compound itself may produce a radical through the application of activation energy such as light, heat, or the like thereto. The radical polymerizable compound may, for example, include compounds having functional groups polymerizable by an active radical of vinyl, (meth)acryloyl, aryl, maleimide, or the like.

Examples of the radical polymerizing compounds may include an oligomer such as an epoxy(meth)acrylate oligomer, a urethane(meth)acrylate oligomer, a polyether(meth)acrylate oligomer, a polyester(meth)acrylate oligomer, or the like, trimethylolpropane tri(meth)acrylate, polyethyleneglycol di(meth)acrylate, polyalkyleneglycol di(meth)acrylate, dicyclopentenyl(meth)acrylate, dicyclopentenyloxyethyl(meth)acrylate, neopentylglycol di(meth)acrylate, dipentaerythritol hexa(meth)acrylate, isocyanuric acid modified 2 functional (meth)acrylate, isocyanuric acid modified 3 functional (meth)acrylate, bisphenoxyethanol fluorene acrylate, epoxy(meth)acrylate obtained by adding (meth)acrylic acid to the glycidyl group of bisphenolfluorene diglycidyl ether, bisphenoxyethanol fluorene acrylate, epoxy(meth)acrylate obtained by adding (meth)acrylic acid to the glycidyl group of bisphenolfluorene diglycidyl ether, a compound introducing a (meth)acrylolyoxy group into a compound obtained by adding ethylene glycol or propylene glycol to the glycidyl group of bisphenolfluorene diglycidyl ether, a compound represented by general formula (A) or (B), etc.

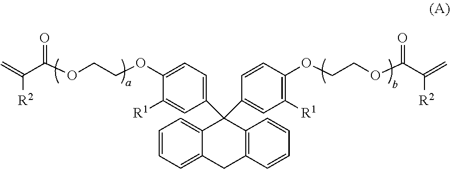

In general formula (A), R¹ and R² each independently represent a hydrogen atom or a methyl group, and a and b each independently represent an integer of 1 to 8.

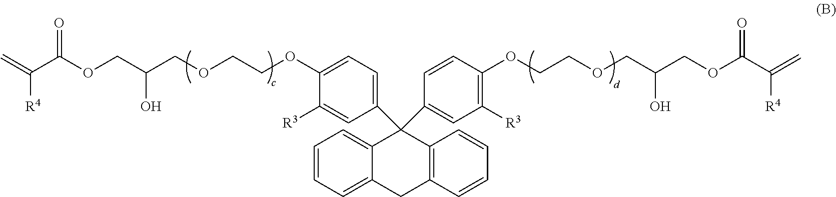

In general formula (B), R³ and R⁴ each independently represent a hydrogen atom or a methyl group, and c and d each independently represent an integer of 0 to 8.

Any type of the radical polymerizable compounds may be used without restriction even though in a solid state having no fluidity such as a wax state, a beeswax state, a crystalline state, a glass state, a powder state, etc. when stood alone at 30° C. Particularly, the radical polymerizable compounds may include N,N′-methylene bisacrylamide, diacetone acrylamide, N-methylol acrylamide, N-phenyl methacrylamide, 2-acrylamide-2-methyl propane sulfonic acid, tris(2-acrylolyloxy ethyl)isocyanurate, N-phenyl maleimide, N-(o-methylphenyl)maleimide, N-(m-methylphenyl)maleimide, N-(p-methylphenyl)-maleimide, N-(o-methoxyphenyl)maleimide, N-(m-methoxyphenyl)maleimide, N-(p-methoxyphenyl)-maleimide, N-methyl maleimide, N-ethyl maleimide, N-octyl maleimide, 4.4′-diphenyl methane bismaleimide, m-phenylene bismaleimide, 3,3′-dimethyl-5,5′-dimethyl-4,4′-diphenyl methane bismaleimide, 4-methyl-1,3-phenylene bismaleimide, N-methacryloxymaleimide, N-acryloxymaleimide, 1,6-bismaleimide-(2,2,4-trimethyl)hexane, N-methacryloxy succinimide, N-acryloyloxy succinimide, 2-naphtyl methacrylate, 2-naphtyl acrylate, pentaerythritol tetracrylate, divinyl ethylene urea, divinyl propylene urea, 2-polystyryl ethylene methacrylate, N-phenyl-N′-(3-methacryloyloxy-2-hydroxypropyl)-p-phenylenediamine, N-phenyl-N′-(3-acryloyloxy-2-hydroxypropyl)-p-phenylenediamine, tetramethylpiperidyl methacrylate, tetramethylpiperidyl acrylate, pentamethylpiperidyl methacrylate, pentamethylpiperidyl acrylate, octadecyl acrylate, N-t-butyl acrylamide, diacetone acrylamide, N-(hydroxymethyl)acrylamide, and a compound represented by one of the following general formulae (C) to (L).

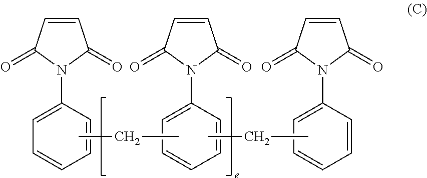

In general formula (C), e represents an integer of 1 to 10.

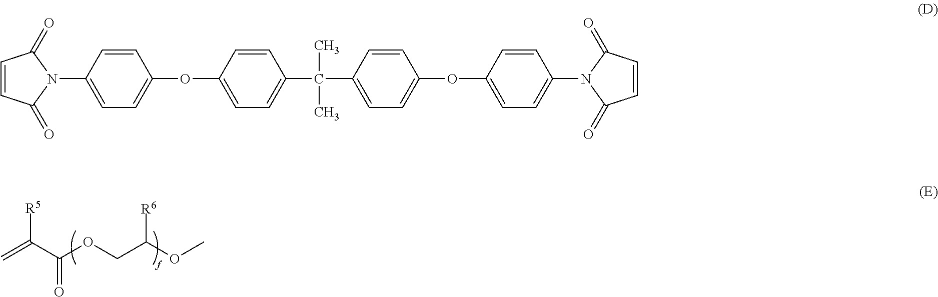

In general formula (E), R⁵ and R⁶ each independently represent a hydrogen atom or a methyl group, and f represents an integer of 15 to 30.

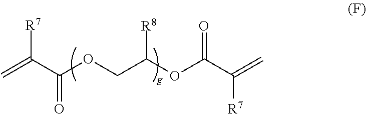

In general formula (F), R⁷ and R⁸ each independently represent a hydrogen atom or a methyl group, and g represents an integer of 15 to 30.

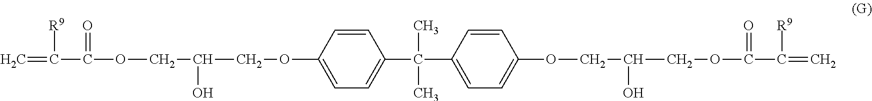

In general formula (G), R⁹ represents a hydrogen atom or a methyl group.

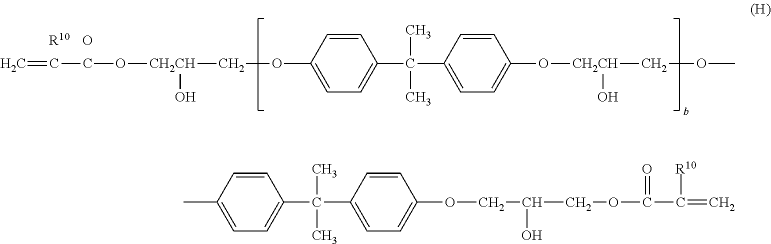

In general formula (H), R¹⁰ represents a hydrogen atom or a methyl group, and h represents an integer of 1 to 10.

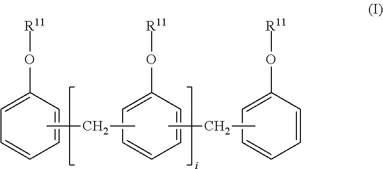

In general formula (I), R¹¹ represents a hydrogen atom or an organic group represented by the following general formula (I) or (ii), and i represents an integer of 1 to 10.

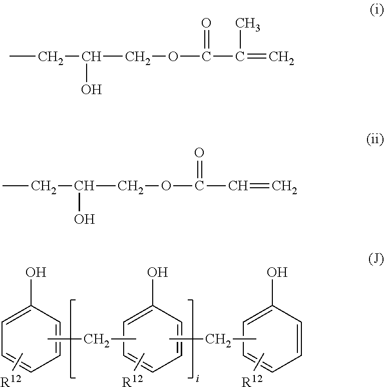

In general formula (J), R¹² represents a hydrogen atom or an organic group represented by the following general formula (iii) or (iv), and j represents an integer of 1 to 10. In addition, each of R¹² may be the same or different.

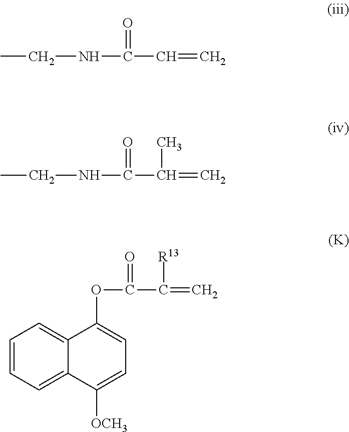

In general formula (K), R¹³ represents a hydrogen atom or a methyl group.

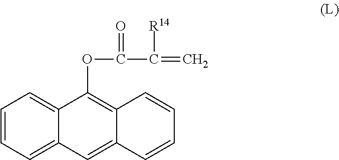

In general formula (L), R¹⁴ represents a hydrogen atom or a methyl group.

In addition, as for the radical polymerizable compound, urethane (meth)acrylate may be used alone or in combination with other radical polymerizable compounds. In using urethane (meth)acrylate, flexibility may be improved and the bonding strength of a bond to an organic material such as PET, PC, PEN, COP, or the like may be increased.

Any urethane (meth)acrylate may be used without specific limitation, however, urethane (meth)acrylate represented by the following general formula (M) is preferably used. Urethane (meth)acrylate represented by general formula (M) may be prepared by condensing aliphatic or alicyclic diisocyanate with at least one aliphatic or alicyclic ester diol or aliphatic or alicyclic carbonate diol.

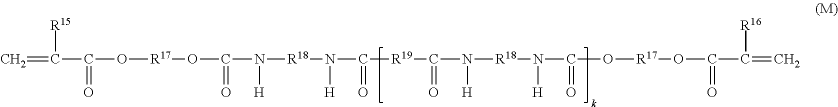

In general formula (M), R¹⁵ or R¹⁶ each independently represents a hydrogen atom or a methyl group, R¹⁷ represents a methylene group or a propylene group, R¹⁸ represents a saturated aliphatic group or a saturated alicyclic group, R¹⁹ represents a saturated aliphatic group or a saturated alicyclic group including an ester group, a saturated aliphatic group or a saturated alicyclic group including a carbonate group, and k represents an integer of 1 to 40. In the formula, each of R¹⁷, each of R¹⁸, each of R¹⁹ may be the same or different.

The aliphatic diisocyanate constituting urethane (meth)acrylate is selected from tetramethylene diisocyanate, hexamethylene diisocyanate, lysine diisocyanate, 2-methylpentane-1,5-diisocyanate, 3-methylpentane-1,5-diisocyanate, 2,2,4-trimethylhexamethylene-1,6-diisocyanate, 2,4,4-trimethylhexamethylene-1,6-diisocyanate, isophorone diisocyanate, cyclohexyl diisocyanate, hydrogenated xylylene diisocyanate, hydrogenated diphenylmethane diisocyanate, hydrogenated trimethylxylylene diisocyanate etc.

The aliphatic ester diol constituting urethane (meth)acrylate is selected from saturated low molecular weight glycols such as ethylene glycol, propylene glycol, 1,2-propanediol, 1,3-propanediol, 1,3-butanediol, 1,4-butanediol, neopentyl glycol, 1,2-pentanediol, 1,4-pentanediol, 1,5-pentanediol, 2,4-pentanediol, 2-methyl-2,4-pentanediol, 2,4-dimethyl-2,4-pentanediol, 2,2,4-trimethyl-1,3-pentanediol, 1,2-hexanediol, 1,5-hexanediol, 1,6-hexanediol, 2,5-hexanediol, 2-ethyl-1,3-hexanediol, 2,5-dimethyl-2,5-hexanediol, 1,2-octanediol, 1,8-octanediol, 1,7-heptanediol, 1,9-nonandiol, 1,2-decanediol, 1,10-decanediol, 1,12-decanediol, dodecanediol, pinacol, 1,4-butyldiol, triethylene glycol, diethylene glycol, dipropylene glycol, cyclohexane dimethanol, 1,4-cyclohexane dimethanol, etc. and dibasic acids such as adipic acid, 3-methyl adipic acid, 2,2,5,5-tetramethyl adipic acid, maleic acid, fumaric acid, succinic acid, 2,2-dimethyl succinic acid, 2-ethyl-2-methyl succinic acid, 2,3-dimethyl succinic acid, oxalic acid, malonic acid, methyl malonic acid, ethyl malonic acid, butyl malonic acid, dimethyl malonic acid, glutaric acid, 2-methyl glutaric acid, 3-methyl glutaric acid, 2,2-dimethyl glutaric acid, 3,3-dimethyl glutaric acid, 2,4-dimethyl glutaric acid, pimelic acid, suberic acid, azelaic acid, sebacic acid, etc. or polyester diols obtained by dehydrocondensating corresponding acid anhydrides or polyester diols obtained by opening cyclic ester compounds such as ε-caprolactone, etc. The polyester diols prepared from the diols and the dicarbonic acids may be used alone or in a mixture of two or more compounds thereof.

The carbonate diols constituting urethane (meth)acrylate is selected from polycarbonate diols prepared by reacting at least one of the glycols and phosgene. The polycarbonate diols prepared by the reaction of the glycols and phosgene may be used alone or in a mixture of two or more compounds thereof.

The weight average molecular weight of urethane (meth)acrylate may be optionally controlled and appropriately used within a range of not less than 5,000 to less than 30,000 from the view point of increasing bonding strength on a material of PET, PC, PEN, COP, or the like. When the weight average molecular weight of urethane (meth)acrylate is within the range, both flexibility and cohesiveness may be obtainable, the bonding strength of a bond to an organic material such as PET, PC, PEN, COP, or the like may be improved, and excellent connection reliability may be attained. In addition, when the weight average molecular weight of urethane (meth)acrylate is within the range, the flexibility and sufficiently high fluidity of the adhesive composition may be easily accomplished. In view of obtaining the effects to a sufficient degree, the weight average molecular weight of urethane (meth)acrylate is preferably within a range of not less than 80,000 to less than 25,000, and is particularly preferably within a range of not less than 10,000 to less than 20,000.

The weight average molecular weight in exemplary embodiments may be obtained by measuring using a Gel Permeation Chromatography (GPC) analysis and then, calculating using a standard polystyrene gauging line. The GPC condition is as follows.

Apparatus: Hitachi L-6000 type (manufactured by Hitachi Co., Ltd., trade name)

Detector: L-3300RI (manufactured by Hitachi Co., Ltd., trade name)

Column: Gelpack GL-R420+Gelpack GL-R430+Gelpack GL-R440 (three in total) (manufactured by Hitachi Chemical Co., Ltd., trade name)

Eluent: tetrahydrofurane

Measuring Temperature: 40° C.

Flow rate: 1.75 ml/min

The mixing amount of urethane (meth)acrylate based on the amount of the adhesive components (adhesive composition excluding conductive particles) is preferably 5 wt % to 95 wt %, is more preferably 10 wt % to 80 wt %, and is particularly preferably 15 wt % to 70 wt %. Within the mixing amount range of urethane (meth)acrylate, a sufficient degree of heat-resistance may be obtained after curing, and improved film forming properties may be attained when used as a film-like adhesive.

In addition, vinyl compounds having a phosphoric acid group (phosphoric acid-containing vinyl compounds) included in the radical polymerizable compounds, or N-vinyl-based compounds selected from the group consisting of N-vinyl compound and N,N-dialkylvinyl compound, may be used in combination with other radical polymerizable compounds. The adhesiveness of the adhesive composition to a metal base may be improved by using the phosphoric acid-containing vinyl compounds in combination. In addition, the cross-linking degree of the adhesive composition may be increased by using the N-vinyl-based compounds in combination.

As the phosphoric acid-containing compounds, all compounds including the phosphoric acid group and the vinyl group may be used without limitation, and preferably, the following compounds represented by general formulae (N) to (P) may be used.

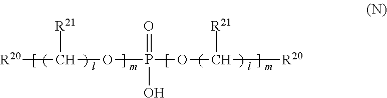

In general formula (N), R²⁰ represents a (meth)acryloyloxy group, R²¹ represents a hydrogen atom or a methyl group, and 1 and m represent each independently represent an integer of 1 to 8. In the formula, each of R²⁰, each of R²¹, each of 1, and each of m may be the same or different.

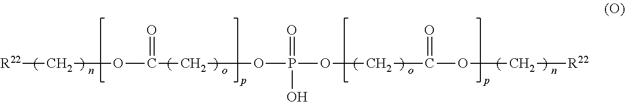

In general formula (O), R²² represents a (meth)acryloyloxy group, and n, o and p each independently represent an integer of 1 to 8. In the formula, each of R²², each of n, each of o, and each of p may be the same or different.

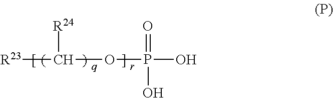

In general formula (P), R²³ represents a (meth)acryloyloxy group, R²⁴ represents a hydrogen atom or a methyl group, and q and r each independently represent an integer of 1 to 8. In the formula, each of R²³, each of R²⁴, each of q, and each of r may be the same or different.

Particular examples of the vinyl compounds including the phosphoric acid group may include acid phosphoxy ethyl methacrylate, acid phosphoxy ethyl acrylate, acid phosphoxy propyl methacrylate, acid phosphoxy polyoxy ethylene glycol monomethacrylate, acid phosphoxy polyoxy propylene glycol monomethacrylate, 2,2′-di(meth)acryloyloxy diethyl phosphate, EO modified phosphoric acid dimethacrylate, phosphoric acid modified epoxyacrylate, vinyl phosphate, etc.

Examples of the N-vinyl compounds may include N-vinylimidazole, N-vinylpyridine, N-vinylpyrrolidone, N-vinylformamide, N-vinylcaprolactam, 4,4′-vinylidene bis(N,N-dimethylaniline), N-vinylacetamide, N,N-dimethylacrylamide, N,N-diethylacrylamide, etc.

The mixing amount of the vinyl compounds including the phosphoric acid group and the N-vinyl compounds based on the amount of the adhesive components (adhesive composition excluding conductive particles) is preferably 0.2 wt % to 15 wt %, is more preferably 0.3 wt % to 10 wt %, and is particularly preferably 0.5 wt % to 5 wt %. Within the mixing amount range of the vinyl compounds including the phosphoric acid group and the N-vinyl compounds, both high bonding strength and good properties after curing may be easily attained, and reliability may be easily confirmed.

The mixing amount of the radical polymerizable compound except for the vinyl compounds including the phosphoric acid group and the N-vinyl compounds based on the amount of the adhesive components (adhesive composition excluding conductive particles) is preferably 5 wt % to 95 wt %, is more preferably 10 wt % to 80 wt %, and is particularly preferably 15 wt % to 70 wt %. Within the mixing amount range of the radical polymerizable compound, a sufficient degree of heat-resistance may be obtained after curing, and improved film forming properties may be attained when used as a film-like adhesive.

As the radical polymerization initiator, commonly known compounds generating radicals by an external energy such as organic peroxides or azo compounds, etc. may be used. In view of stability, reactivity, compatibility, the organic peroxides having a half-life temperature for one minute of 90° C. to 175° C., and a molecular weight of 180 to 1,000 may be preferably used. When the half-life temperature for one minute is in the range, excellent storage stability, a sufficiently high degree of polymerization, and rapid curing, may be attained.

As the radical polymerization initiator, particular examples may include peroxy compounds such as 1,1,3,3-tetramethylbutylperoxy neodecanoate, di(4-t-butylcyclohexyl)peroxy dicarbonate, di(2-ethylhexyl)peroxy dicarbonate, cumylperoxy neodecanoate, 1,1,3,3-tetramethylbutylperoxy neodecanoate, dilauroyl peroxide, 1-cyclohexyl-1-methylethylperoxy neodecanoate, t-hexylperoxy neodecanoate, t-butylperoxy neodecanoate, t-butylperoxy pivalate, 1,1,3,3-tetramethylbutylperoxy-2-ethyl hexanoate, 2,5-dimethyl-2,5-di(2-ethylhexanoylperoxy)hexane, t-hexylperoxy-2-ethylhexanoate, t-butylperoxy-2-ethyl hexanoate, t-butylperoxy neoheptanoate, t-amylperoxy-2-ethyl hexanoate, di-t-butylperoxy hexahydroterephthalate, t-amylperoxy-3,5,5,-trimethyl hexanoate, 3-hydroxy-1,1-dimethylbutylperoxy neodecanoate, 1,1,3,3-tetramethylbutyl peroxy-2-ethylhexanoate, t-amylperoxy neodecanoate, t-amylperoxy-2-ethyl hexanoate, di(3-methylbenzoyl)peroxide, dibenzoperoxide, di(4-methylbenzoyl)peroxide, t-hexylperoxyisopropyl monocarbonate, t-butylperoxymaleic acid, t-butylperoxy-3,5,5-trimethyl hexanoate, t-butylperoxy laurate, 2,5-dimethyl-2,5-di(3-methylbenzoylperoxy)hexane, t-butylperoxy-2-ethylhexyl monocarbonate, t-hexylperoxybenzoate, 2,5-dimethyl-2,5-di(benzoylperoxy)hexane, t-butylperxoybenzoate, dibutylperoxy trimethyladipate, t-amylperoxy normaloctate, t-amylperoxy isononanoate, t-amylperoxy benzoate, etc., azo compounds such as 2,2′-azobis-2,4-dimethyl valeronitrile, 1,1′-azobis(1-acetoxy-1-phenylethane), 2,2′-azobisisobutyronitrile, 2,2′-azobis(2-methylbutyronitrile), dimethyl-2,2′-azobisisobutyronitrile, 4,4′-azobis(4-cyanovaleric acid), 1,1′-azobis(1-cyclohexanecarbonitrile), etc. These compounds may be used alone or in a mixture of two or more compounds thereof.

As the radical polymerization initiator, compounds producing radicals by an exposure to light having a wavelength of 150 nm to 750 nm may be used. Examples of the initiator include, for example, α-acetaminophenone derivatives or phosphine oxide derivatives disclosed in Photoinitiation, Photopolymerization, and Photocuring, J.-P. Fouassier, Hanser Publishers (1995, p17-p35). These compounds may be used alone or may be mixed with the organic peroxides or the azo compounds.

The mixing amount of the radical polymerization initiator based on the amount of the adhesive components (adhesive composition excluding conductive particles) is preferably 0.5 wt % to 40 wt %, is more preferably 1 wt % to 30 wt %, and is particularly preferably 2 wt % to 20 wt %. Within the mixing amount range of the radical polymerization initiator, both the curing properties and the storage stability of the adhesive composition may be easily attained.

As the thermoplastic resin included in the adhesive composition, a resin (polymer) having properties of being in a liquid state having a high viscosity by heating, freely modifying the shape by an external force, being cured while retaining the shape after cooling and removing the external force, and possibly repeating these processes, may be appropriately used. A resin (polymer) having a reactive functional group having the above-described properties may also be used. Tg of the thermoplastic resin is preferably, −30° C. to 190° C., more preferably, −25° C. to 170° C., and particularly preferably, −20° C. to 150° C.

The thermoplastic resin may include a polyimide resin, a polyamide resin, a phenoxy resin, a (meth)acryl resin, an urethane resin, a polyester urethane resin, a polyvinyl butyral resin, an acetic acid vinyl copolymer, etc. These compounds may be used alone or in a mixture of two or more thereof. The thermoplastic resin may include a siloxane bonding or a fluorine substituent. These may be appropriately used when the resins mixed are completely compatible or when a microphase separation is generated to generate a cloudy state.

When the adhesive composition is molded into a film-like shape, and the film-like adhesive is used, film forming properties may be improved, and melting viscosity, interrelated with fluidity, may be set in a wide range when the molecular weight of the thermoplastic resin is high. The weight average molecular weight of the thermoplastic resin is preferably 5,000 to 150,000, more preferably 7,000 to 100,000, and particularly preferably 10,000 to 80,000. When the molecular average molecular weight is within the above-detailed ranges, good film forming properties and compatibility with other components may be easily attained.

The weight average molecular weight in exemplary embodiments may be measured by a Gel Permeation Chromatography (GPC) analysis under the following conditions, and may be obtained by a conversion using a standard polystyrene gauging line. The GPC condition is as follows.

Apparatus: Hitachi L-6000 type (manufactured by Hitachi Co., Ltd., trade name)

Detector: L-3300RI (manufactured by Hitachi Co., Ltd., trade name)

Column: Gelpack GL-R420+Gelpack GL-R430+Gelpack GL-R440 (three in total) (manufactured by Hitachi Chemical Co., Ltd., trade name)

Eluent: tetrahydrofurane

Measuring Temperature: 40° C.

Flow rate: 1.75 ml/min

The mixing amount of the thermoplastic resin based on the amount of the adhesive components (adhesive composition excluding conductive particles) is preferably 5 wt % to 80 wt %, and is more preferably 15 wt % to 70 wt %. When the molecular average molecular weight is in the range, good film forming properties and compatibility with other components may be easily attained.

Preferred conductive particles included in the adhesive composition are conductive particles or particles at least the surface of which is conductive. When the adhesive composition is used for connecting circuit members having connecting terminals (circuit electrodes), it is more preferable that the mean diameter of the conductive particles is smaller than the distance between connecting terminals.

The conductive particles may include metal particles such as Au, Ag, Ni, Cu, Pd, solder, or the like, or carbon, or the like. In addition, the conductive particles may be obtained by coating a core of nonconductive glass, ceramic, plastic, or the like with a metal, metal particles or carbon. When the conductive particles are particles obtained by coating a plastic core with the metal, the metal particles or the carbon, or are heat-melting metal particles, the shape may be modified by heat and pressure. Thus, a contact area with an electrode may be preferably increased while performing a connection process to improve reliability. In addition, the conductive particles may be particles obtained by coating copper metal particles with silver. Further, the conductive particles may be obtained by using a metal powder having a plurality of connected ring shapes of minute metal particles as disclosed in Japanese Unexamined Patent Application Publication No. 2005-116291.

In addition, particles obtained by further coating the surface of the conductive particles with insulating particles, and particles including an insulating layer formed by using an insulating material on the surface of the conductive particles by means of a method such as hybridization, etc. may induce a short due to contact between particles when the amount of the conductive particles is increased, and may improve insulating properties between electrode circuits. These particles may be appropriately used alone or in a mixture with other conductive particles.

The mean diameter of the conductive particles is preferably 1 μm to 18 μm when considering the dispersibility and conductivity thereof. The adhesive composition including these conductive particles may be appropriately used as an anisotropic conductive adhesive.

The amount of the conductive particles is not limited to a specific range, however, is preferably within 0.1 vol % to 30 vol % based on the total volume of the adhesive composition, and is more preferably in 0.1 vol % to 10 vol %. When the amount of the conductive particles is in the range, a sufficient degree of conductivity may be obtainable and short circuiting may be sufficiently suppressed. The vol % is determined at 23° C. based on the volume of each component before the curing, and the volume of each component may be converted from the weight to the volume by using specific gravity. Otherwise, the volume of each component may be obtained by adding the component to an appropriate solvent (water, alcohol, etc.), which may wet the component while not dissolving or expanding the component, in a graduated cylinder, or the like and then by measuring an increased volume.

In order to suppress a curing rate or to impart storage stability, a stabilizer may be added into the adhesive composition. The stabilizer may include known compounds without limitation, and may preferably include quinone derivatives such as benzoquinone or hydroxyquinone, or the like, phenol derivatives such as 4-methoxy phenol or 4-t-butyl catechol, or the like, aminoxyl derivatives such as 2,2,6,6-tetramethyl piperidine-1-oxyl or 4-hydroxy-2,2,6,6-tetramethyl piperidine-1-oxyl, or the like, hindered amine derivatives such as tetramethyl piperidyl methacrylate, or the like.

The mixing amount of the stabilizer based on the amount of the adhesive components (adhesive composition excluding conductive particles) is preferably in a range of 0.005 wt % to 10 wt %, more preferably in 0.01 wt % to 8 wt %, and particularly preferably in 0.02 wt % to 5 wt %. When the mixing amount of the stabilizer is in the range, the control of the curing rate and the provision of the storage stability may become possible without affecting the compatibility with other components.

An appropriate supplemental agent for adhesion such as a coupling agent typically including alkoxysilane derivatives or silazane derivatives, a contact improving agent, a leveling agent, or the like may be added in the adhesion composition. Particularly, a preferred coupling agent may include a compound represented by the following general formula (Q) and may be used alone or in a mixture of two or more compounds.

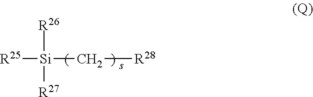

In general formula (Q), R²⁵, R²⁶ and R²⁷ each independently represent a hydrogen atom, an alkyl group having a carbon number of 1 to 5, an alkoxy group having a carbon number of 1 to 5, an alkoxycarbonyl group having a carbon number of 1 to 5 or an aryl group, R²⁸ represents a (meth)acryloyl group, a vinyl group, an isocyanate group, an imidazol group, a mercapto group, an amino group, a methylamino group, a dimethylamino group, a benzylamino group, a phenylamino group, a cyclohexylamino group, a morpholino group, a piperazino group, an ureid group or a glycidyl group, and s represents an integer of 1 to 10.

A rubber component may be included in the adhesive composition to improve adhesiveness. The rubber component represents a component illustrating rubber elasticity (JIS K6200) or a component illustrating the rubber elasticity through a reaction. The rubber component may have a solid state or a liquid state at room temperature (25° C.). In view of fluidity, the liquid state is preferable. Components having a polybutadiene skeleton are preferably used as the rubber component. The rubber component may include a cyano group, a carboxyl group, a hydroxyl group, a (meth)acryloyl group or a morpholino group. In view of the improvement of the adhesiveness, rubber components including a highly polar group such as the cyano group or the carboxyl group at a side chain or terminal portion may be preferred. When a compound even though including the polybutadiene skeleton illustrates thermoplastic properties, this compound is classified as the thermoplastic resin, and when the compound illustrates radical polymerizing properties, this compound is classified as the radical polymerizable compound.

Particularly, the rubber component includes polyisoprene, polybutadiene, carboxyl-terminated polybutadiene, hydroxyl-terminated polybutadiene, 1,2-polybutadiene, carboxyl-terminated 1,2-polybutadiene, hydroxyl-terminated 1,2-polybutadiene, acryl rubber, styrene-butadiene rubber, hydroxyl-terminated styrene-butadiene rubber, acrylonitrile-butadiene rubber, carboxyl-, hydroxyl-, (meth)acryloyl- or morpholino-terminated acrylonitrile-butadiene rubber, carboxlylated nitrile rubber, hydroxyl-terminated poly(oxypropylene), alkoxysilyl-terminated poly(oxypropylene), poly(oxytetramethylene)glycol, polyolefine glycol, etc.

In addition, the rubber component having the highly polar group and the liquid state at room temperature may include liquid state acrylonitrle-butadiene rubber, liquid state acrylonitrile-butadiene rubber including a carboxyl group, a hydroxyl group, a (meth)acryloyl group or a morpholino group at the terminal of the polymer, liquid state carboxylated nitrile rubber, or the like. The amount of the polar acrylonitrile is preferably 10 wt % to 60 wt %.

These compounds may be used alone or in a mixture of two or more compounds thereof.

The adhesive composition may additionally include organic particles besides the core-shell silicon particles in order to relieve stress and to increase adhesiveness. The mean diameter of the organic particles is preferably 0.05 μm to 1.0 μm. When the organic particles include the rubber component, the organic particles are classified as the rubber component, and when the organic particles include the thermoplastic resin, the organic particles are classified as the thermoplastic resin.

Particularly, the organic particles may include polyisoprene, polybutadiene, carboxyl-terminated polybutadiene, hydroxyl-terminated polybutadiene, 1,2-polybutadiene, carboxyl-terminated 1,2-polybutadiene, acryl rubber, styrene-butadiene rubber, acrylonitrile-butadiene rubber, carboxyl-, hydroxyl-, (meth)acryloyl- or morpholino-terminated acrylonitrile-butadiene rubber, carboxlylated nitrile rubber, hydroxyl-terminated poly(oxypropylene), alkoxysilyl-terminated poly(oxypropylene), poly(oxytetramethylene)glycol, polyolefine glycol(meth)acrylic acid alkyl-butadiene-styrene copolymer, (meth)acrylic acid alkyl-silicon copolymer, or silicon(meth)-acryl copolymer, or a complex.

When the adhesive composition is in a liquid state at room temperature, it may be used in a paste state. When the adhesive composition is in a solid state at room temperature, the composition may become a paste by heating or by using a solvent. Preferably useful solvents have no reactivity with the adhesive composition and the additive and have a sufficient degree of solubility. The preferred boiling temperature of the solvent at an atmospheric pressure is 50° C. to 150° C. When the boiling point of the solvent is within this range, the solvent may not volatilize when stood at room temperature. Thus, the solvent may be readily used in an open system, and the solvent may volatilize satisfactorily after conducting the adhesion to confirm a sufficient degree of reliability.

In addition, the adhesive composition in accordance with exemplary embodiments may be molded into a film shape to be used as a film-like adhesive. A solution including the adhesive composition optionally including a solvent, etc. as occasion needs, may be coated on a separable base such as a fluorine resin film, a polyethylene terephthalate film, a separating film, etc., or a base such as a non-woven fabric, etc. is impregnated with the solution and is put on the separable base. Then, the solvent is removed to obtain the film-like adhesive. The film is even more convenient in handling.

The adhesive composition in accordance with exemplary embodiments may be used by applying both heat and pressure. The preferred heating temperature is 100° C. to 200° C. The preferred pressure is determined to be within a range in which damage to the adhesive is not generated, and in general is 0.1 MPa to 10 MPa. The heating and the pressurizing is preferably conducted for 0.5 seconds to 120 seconds. The adhesion may be performed by heating at 110° C. to 190° C. with 3 MPa for 10 seconds.

The adhesive composition of exemplary embodiments may be used as an adhesive composition for different adherents having different thermal expansion coefficients. Particularly, the adhesive composition may be used as a circuit connecting material, typically as an anisotropic conductive adhesive, a silver paste, a silver film, or the like.

When circuit members are connected using the adhesive composition in accordance with exemplary embodiments of the present invention, the adhesive composition in accordance with exemplary embodiments may be interposed between a first circuit member including a first circuit electrode formed on a first circuit substrate, and a second circuit member including a second circuit electrode formed on a second circuit substrate and cured. Then, the first circuit electrode and the second circuit electrode are electrically connected and the first circuit member and the second member are bonded to manufacture a circuit connection structure.

At least one of the first circuit substrate and the second circuit substrate includes a thermoplastic resin having a glass transition temperature of not more than 200° C. and including at least one selected from the group consisting of polyethylene terephthalate, polycarbonate and polyethylene naphthalate. Through introducing the thermoplastic resin, the wettability with the adhesive composition of exemplary embodiments of the present invention is improved and thus bonding strength and connection reliability are increased.

In addition, it is preferred that one circuit substrate among the first circuit substrate and the second circuit substrate includes at least one selected from the group consisting of polyethylene terephthalate, polycarbonate and polyethylene naphthalate, and the other circuit substrate includes at least one selected from the group consisting of a polyimide resin, polyethylene terephthalate, polycarbonate, polyethylene naphthalate and a cycloolefin polymer. Through introducing the circuit substrate, the wettability with the adhesive composition of exemplary embodiments of the present invention is improved and thus bonding strength and connection reliability are increased.

As the circuit substrate, inorganic substrates such as semiconductor, glass, ceramic, etc., and organic substrates may be used in combination.

The adhesive composition in accordance with exemplary embodiments of the present invention does not necessarily reach a complete curing state (a maximum curing degree obtainable by a certain curing condition), and may reach to a partial curing state only when the above properties may be obtained.

### EXAMPLES

Hereinafter, preferred embodiments on the present invention will be described in detail. However, the present invention is not restricted to the following embodiments.

### [Manufacturing of Conductive Particles]

On the surface of particles including polystyrene as a core, a nickel layer was formed to have a thickness of 0.2 μm, and on the outer surface of the nickel layer, a gold layer was formed to a thickness of 0.02 μm to manufacture conductive particles having a mean diameter of 10 μm and a specific gravity of 2.5.

### [Preparation of Adhesive Composition]

Adhesive compositions according to Examples 1 to 5 and Comparative Examples 1 to 11 were prepared by mixing each of the components illustrated in Table 1 by weight in a solid content as illustrated in Table 1 and additionally mixing and dispersing 1.5 vol % of the conductive particles. Hereinafter, each component illustrated in Table 1 will be described in detail.

### [Thermoplastic Resin]

### (Polyester Urethane Resin A)

Polyester urethane resin A having a mole ratio of 0.34/0.66/1.1/0.33 of terephthalic acid/isophthalic acid/neopentyl glycol/4,4′-diphenylmethane diisocyanate, was prepared by using terephthalic acid (manufactured by Aldrich) and isophthalic acid (manufactured by Aldrich) as dicarbonic acids, neopentyl glycol (manufactured by Aldrich) as a diol, and 4,4′-diphenylmethane diisocyanate (manufactured by Aldrich) as an isocyanate compound. Number average molecular weight of thus prepared polyester urethane resin A was 25,000. The prepared polyester urethane resin A (PEU-A) was dissolved in a mixture of methyl ethyl ketone and toluene by 1:1 so that the solid content became 40 wt %.

(YP-50: phenoxy resin)

A phenoxy resin (trade name: YP-50) prepared by Tohto Kasei Co., Ltd. was dissolved in methyl ethyl ketone, and a solution including the solid content of 40 wt % was used.

(EV40W: ethylene-vinyl acetate copolymer)

Ethylene-vinyl acetate copolymer dissolved in toluene (solid content of 30 wt %) (manufactured by Du pont∩Mitsui Polychemicals Co., Ltd., EV40W (trade name)) was used.

### <Radical Copolymerization Compound>

(UA1: urethane(meth)acrylate 1)

Into a reaction vessel equipped with a stirrer, a thermometer, a refluxing and cooling condenser with a calcium chloride drying tube and a nitrogen gas inlet, 2,500 parts by weight (2.50 mol) of poly(1,6-hexanediolcarbonate) having a number average molecular weight of 1,000 (trade name: DURANOL T5652, manufactured by Asahi Kasei Chemicals Corporation), and 666 parts by weight (3.00 mol) of isophorone diisocyanate (manufactured by Sigma Aldrich) were dropped at regular intervals for three hours. A sufficient amount of nitrogen gas was introduced and then, the reactant was heated to a temperature between 70° C. to 75° C. to conduct a reaction.

After that, 0.53 parts by weight of hydroquinone monomethyl ether (purchased from Sigma Aldrich) and 5.53 parts by weight of dibutyltin dilaurate (purchased from Sigma Aldrich) were added, and 238 parts by weight (2.05 mol) of 2-hydroxyethyl acrylate (purchased from Sigma Aldrich) was additionally added. The reaction was conducted under an air atmosphere at 70° C. for 6 hours to prepare urethane(meth)acrylate 1 (UA1).

(UA2: urethane(meth)acrylate 2)

Into a reaction vessel equipped with a stirrer, a thermometer, a refluxing and cooling condenser with a calcium chloride drying tube and a nitrogen gas inlet, 1,000 parts by weight of methyl ethyl ketone, 2,500 parts by weight (2.50 mol) of polycaprolactonediol (trade name: Placcel 210N, Daicel Chemicals Co., Ltd.) having a number average molecular weight of 1,000, and 666 parts by weight (3.00 mol) of isophoronedicyanate (purchased from Sigma Aldrich) were dropped at regular intervals for three hours. A sufficient amount of nitrogen gas was introduced and then, the reactant was heated to a temperature between 70° C. to 75° C. to conduct a reaction.

After that, 0.53 parts by weight of hydroquinone monomethyl ether (manufactured by Sigma Aldrich) and 5.53 parts by weight of dibutyltin dilaurate (manufactured by Sigma Aldrich) were added, and 238 parts by weight (2.05 mol) of 2-hydroxyethyl acrylate (purchased from Sigma Aldrich) was additionally added. The reaction was conducted under an air atmosphere at 70° C. for 6 hours to prepare urethane(meth)acrylate 2 (UA2).

### <Organic Particles>

### (KMP-600)

Core-shell type silicon particles (trade name: KMP-600, mean diameter: 5 μm) manufactured by Shin-etsu Kasei Co., Ltd. were used. The glass transition temperature of the core-shell of these silicon particles was −110° C.

### (BR: Cross-Linked Polybutadiene Particles)

Pure water was put into a stainless steel autoclave and polyvinyl alcohol (purchased from Kanto Chemical Co., Inc.) was added as a suspending agent and then dissolved. Butadiene (Purchased from Sigma Aldrich) was put into the autoclave and then stirred to disperse. Benzoyl peroxide (trade name: Cadox CH-50L, Kayaku Akuzo Co., Ltd.) was added as a radical polymerization initiator and then stirred. Then, the autoclave was heated to 60° C. to 65° C., and polymerization was carried out under stirring for 45 minutes. Unreacted monomers were exhausted and produced and cross-linked polybutadiene particles were dried under vacuum to obtain cross-linked polybutadiene particles (BR). Thus obtained cross-linked polybutadiene particles were dispersed in methyl ethyl ketone, and the mean diameter thereof was measured by means of Zetasizer Nano-S (manufactured by Malvern Instruments Ltd.). The mean diameter of the particles was 0.5 μm.

### (KMP594: Silicon Rubber Particles)

Silicon rubber particles (trade name: KMP594, mean diameter: 5 μm, glass transition temperature: −70° C.) manufactured by Shin-etsu Kasei Co., Ltd. was used.

### (W-5500)

Core-shell type acryl particles (trade name: Metablen W-5500, mean diameter: 0.6 μm) manufactured by Mitsui Rayon Co., Ltd. was used.

### (BTA-712)

Core-shell type acrylic acid alkyl ester-butadiene-styrene copolymer particles (trade name: PARALOID BTA-712) manufactured by Rohm and Haas Co. was used.

### <Vinyl Compound Having Phosphoric Acid Group>

### (P-2M)

2-(meth)acryloyloxyethyl phosphate (trade name: Light Ester P-2M) manufactured by Kyoeisha Chemical Co., Ltd. was used.

### <Radical Polymerization Initiator>

### (Nyper BW)

Dibenzoyl peroxide (trade name: Nyper BW) manufactured by NOF corporation was used.

TABLE 1

| | | | | Radical | | | | | | | | |
|---|---|---|---|---|---|---|---|---|---|---|---|---|
| | | Thermoplastic | | polymerizable | | | | | | | | |
| | | resin | | compound | | organic particles | | | | | | |
| component | | PEU-A | YP-50 | UA1 | UA2 | KMP-600 | BR | KMP594 | W-5500 | BTA-712 | P-2M | Nyper-BW |
| Example | 1 | 50 | — | 50 | — | 10 | — | — | — | — | 3 | 6 |
| | 2 | 50 | — | — | 50 | 10 | — | — | — | — | 3 | 6 |
| | 3 | 50 | — | 50 | — | 20 | — | — | — | — | 3 | 6 |
| | 4 | 50 | — | — | 50 | 20 | — | — | — | — | 3 | 6 |
| | 5 | — | 50 | 50 | — | 10 | — | — | — | — | 3 | 6 |
| Comparative | 1 | 50 | | 50 | — | — | — | — | — | — | 3 | 6 |
| example | 2 | 50 | — | — | 50 | — | — | — | — | — | 3 | 6 |
| | 3 | 50 | — | 50 | — | — | 10 | — | — | — | 3 | 6 |
| | 4 | 50 | — | 50 | — | — | | 10 | | | 3 | 6 |
| | 5 | 50 | — | 50 | — | — | — | — | 10 | — | 3 | 6 |
| | 6 | 50 | — | 50 | — | — | — | — | — | 10 | 3 | 6 |
| | 7 | 50 | — | — | 50 | — | 10 | — | — | — | 3 | 6 |
| | 8 | 50 | — | — | 50 | — | — | 10 | — | — | 3 | 6 |
| | 9 | 50 | — | — | 50 | — | — | — | 10 | — | 3 | 6 |
| | 10 | 50 | — | — | 50 | — | — | — | — | 10 | 3 | 6 |
| | 11 | — | 50 | 50 | — | — | 10 | — | — | — | 3 | 6 |
| | 12 | — | 50 | 50 | — | — | — | 10 | — | — | 3 | 6 |
| | 13 | — | 50 | 50 | — | — | — | | 10 | — | 3 | 6 |
| | 14 | — | 50 | 50 | — | — | — | | — | 10 | 3 | 6 |

### [Forming of Film-Like Adhesive]

The adhesive compositions obtained by Examples 1 to 5 and Comparative Examples 1 to 14 were coated on a fluorine resin film (base) having a thickness of 80 μm by means of a coater and then were dried by hot air at a temperature of 70° C. for 10 minutes to obtain an adhesive sheet including an adhesive layer to a thickness of 20 μm formed on the base. By separating the base from the adhesive sheet, film-like adhesives in accordance with Examples 1 to 10 and Comparative Examples 1 to 11 were obtained. However, in the film-like adhesives in accordance with Comparative Examples 4, 8 and 12, an uneven surface was formed on the adhesive layer by an agglomerating material in KMP594. Therefore, evaluation of the properties of these adhesives could not be conducted.

### [Evaluation on Connection Resistance and Bonding Strength]

### Reference Examples 1 to 9

Each of film-like adhesives in accordance with Examples 1, 2 and 5 and Comparative Examples 3, 5 to 7, 9 and 10 was interposed between a flexible printed circuit (FPC) including 500 copper circuits having a line width of 25 μm, a pitch of 50 μm, and a thickness of 18 μm on a polyimide film (Tg 350° C.) and a glass (thickness 1.1 mm, surface resistance 20Ω/□) including an ITO thin film of 0.2 μm. Then, heat and pressure were applied at a temperature of 150° C., with 2 MPa for 10 minutes by using a thermocompression bonding apparatus (heating manner: constant heat type, manufactured by Toray Engineering Co., Ltd.), and bonding was conducted along a width of 2 mm to manufacture a circuit connection structure.

The resistance between neighboring circuits in the circuit connection structure was measured in millimeter unit immediately after the bonding, and after standing in a high temperature and high humidity bath at 85° C. and 85% RH for 240 hours. The mean value of the resistance values between neighboring circuits was 37.

In addition, the bonding strength of the connection structure was measured and evaluated by a 90 degree separation method based on JIS-Z0237. The bonding strength was measured by using a ‘Tensilon UTM-4’ apparatus (trade name) manufactured by Toyo Baldwin Co., Ltd. (separating rate 50 mm/min, 25° C.). The measured results are illustrated in Table 2.

TABLE 2

| | Connection | | Bonding strength | |
|---|---|---|---|---|
| | resistance (Ω) | | (N/m) | |
| | After | After | After | After |
| | bonding | test | bonding | test |
| Reference example 1 | 2.6 | 3.9 | 650 | 560 |
| (example 1) | | | | |
| Reference example 2 | 2.8 | 3.8 | 640 | 570 |
| (example 2) | | | | |
| Reference example 3 | 2.8 | 3.6 | 650 | 510 |
| (example 5) | | | | |
| Reference example 4 | 2.7 | 3.9 | 630 | 580 |
| (comparative example 3) | | | | |
| Reference example 5 | 2.9 | 3.8 | 680 | 590 |
| (comparative example 5) | | | | |
| Reference example 6 | 3.0 | 3.3 | 710 | 620 |
| (comparative example 6) | | | | |
| Reference example 7 | 2.5 | 3.1 | 640 | 600 |
| (comparative example 7) | | | | |
| Reference example 8 | 2.6 | 3.0 | 670 | 620 |
| (comparative example 9) | | | | |
| Reference example 9 | 2.4 | 2.9 | 720 | 610 |
| (comparative example 10) | | | | |

As found in Table 2, the connection structure in accordance with Reference Examples 1 to 9 illustrate good connection resistance of 4.0Ω or less and good bonding strength of 560 N/m or more immediately after the bonding at a heating temperature of 150° C. and after the test. That is, the kind of the organic particles are found to illustrate not much influence on connection resistance or bonding strength when connecting the flexible printed circuit formed by using a polyimide film and a glass including an ITO thin film.

### Examples 1 to 5 and Comparative Examples 1 to 14

Each of the film-like adhesives in accordance with Examples 1 to 5 and Comparative Examples 1 to 14 was interposed between a flexible printed circuit (FPC) including 80 numbers of copper circuits having a line width of 150 μm, a pitch of 300 μm, and a thickness of 8 μm on a polyimide film (Tg 350° C.) and a PET substrate (thickness 0.1 μm) including an Ag paste thin film having a thickness of 5 μm. Then, heat and pressure were applied at 150° C., with 2 MPa for 20 seconds by using a thermocompression bonding apparatus (heating manner: constant heating manner, manufactured by Toray Engineering Co., Ltd.), and the bonding was conducted along a width of 2 mm to manufacture a circuit connection structure.

The resistance between neighboring circuits in the circuit connection structure was measured in millimeter unit immediately after the bonding, and after retaining in a high temperature and high humidity bath at 85° C. and 85% RH for 240 hours. The mean value of the resistances between neighboring circuits was 37. The measured results are illustrated in Table 3.

Each of the film-like adhesives in accordance with Examples 1 to 5 and Comparative Examples 1 to 14 was interposed between a substrate including a PET, PC or PEN film having a thickness of 0.1 μm and a silver paste circuit having a line width of 150 μm, a pitch of 300 μm, and a thickness of 10 μm on the substrate, and the FPC. Then, heat and pressure were applied at 150° C., with 2 MPa for 20 seconds by using the thermocompression bonding apparatus, and the bonding was conducted along a width of 2 mm to manufacture a circuit connection structure.

The bonding strength of the connection structure was measured and evaluated by a 90 degree separation method based on JIS-Z0237. The bonding strength was measured by using a ‘Tensilon UTM-4’ apparatus (trade name) manufactured by Toyo Baldwin Co., Ltd. (separating rate 50 mm/min, 25° C.). The measured results are illustrated in Table 3.

TABLE 3

| | Connection | | Bonding strength (N/m) | | | | | |
|---|---|---|---|---|---|---|---|---|
| | resistance (Ω) | | PET | | PC | | PEN | |
| | After | | After | | After | | After | |
| | bond- | After | bond- | After | bond- | After | bond- | After |
| | ing | test | ing | test | ing | test | ing | test |
| Example 1 | 1.2 | 1.9 | 780 | 710 | 760 | 660 | 740 | 690 |
| Example 2 | 0.9 | 1.8 | 750 | 700 | 750 | 680 | 710 | 660 |
| Example 3 | 1.4 | 2.0 | 690 | 650 | 700 | 630 | 660 | 630 |
| Example 4 | 1.2 | 1.8 | 680 | 650 | 670 | 640 | 660 | 620 |
| Example 5 | 1.2 | 2.6 | 650 | 610 | 680 | 600 | 630 | 590 |
| Comparative | 1.4 | 2.5 | 500 | 390 | 550 | 320 | 490 | 380 |
| Example 1 | | | | | | | | |
| Comparative | 1.3 | 2.2 | 490 | 330 | 510 | 340 | 500 | 370 |
| Example 2 | | | | | | | | |
| Comparative | 1.2 | 2.3 | 510 | 450 | 520 | 430 | 530 | 480 |
| Example 3 | | | | | | | | |
| Comparative | 1.1 | 2.0 | 590 | 500 | 550 | 480 | 560 | 510 |
| Example 5 | | | | | | | | |
| Comparative | 1.3 | 2.2 | 550 | 490 | 560 | 470 | 580 | 510 |
| Example 6 | | | | | | | | |
| Comparative | 1.1 | 2.0 | 500 | 480 | 520 | 450 | 520 | 460 |
| Example 7 | | | | | | | | |
| Comparative | 1.0 | 2.4 | 570 | 500 | 540 | 450 | 560 | 510 |
| Example 9 | | | | | | | | |
| Comparative | 1.0 | 2.3 | 520 | 490 | 560 | 450 | 560 | 460 |
| Example 10 | | | | | | | | |
| Comparative | 1.2 | 2.5 | 400 | 390 | 450 | 380 | 490 | 400 |
| Example 11 | | | | | | | | |
| Comparative | 1.4 | 2.6 | 420 | 380 | 410 | 370 | 450 | 370 |
| Example 13 | | | | | | | | |
| Comparative | 1.3 | 2.4 | 410 | 350 | 430 | 360 | 450 | 380 |
| Example 14 | | | | | | | | |

The connection structures in accordance with Examples 1 to 5 illustrate good connection resistance of 2.6Ω or less and good bonding strength of 600 N/m or more immediately after the bonding at a heating temperature of 150° C. and after the test.

In comparison, the connection structures obtained by using the film-like adhesives excluding silicon particles in accordance with Comparative Examples 1 to 14 (except for Comparative Examples 4, 8 and 12) illustrate good connection resistance, however, illustrate low bonding strength of 590 N/m immediately after the bonding and 510 N/m or less after the test.

From the result, it would be confirmed that excellent bonding strength may be obtained even under a low temperature curing condition, and a stable performance (bonding strength or connection resistance) may be retained after a reliability test (a high temperature and high humidity test) for a long time, when bonding a pair of circuit members including at least one circuit substrate including a thermoplastic resin having a glass transition temperature of not more than 200° C., by using the adhesive composition including silicon particles in accordance with the present invention.

Since the adhesive composition in accordance with exemplary embodiments of the present invention illustrate excellent bonding strength even after being cured at a low temperature with respect to a circuit substrate including the thermoplastic resin having the glass transition temperature of not more than 200° C., the adhesive composition may be appropriately used in adhering of a semiconductor device using an organic material having low heat-resistance such as PRT, PC, PEN, COP, etc. with FPC, etc.

### LIST OF REFERENCE SIGNS

5 . . . adhesive sheet, 6 . . . base, 8 . . . adhesive layer (adhesive composition), 9 . . . adhesive components, 10 . . . silicon particles, 10a . . . core-shell silicon particle, 11 . . . core layer, 12 . . . shell layer, 20 . . . conductive particles, 30 . . . first circuit member, 31 . . . first circuit substrate, 31a . . . main surface portion of first circuit substrate, 32 . . . first circuit electrode, 40 . . . second circuit member, 41 . . . second circuit substrate, 41a . . . main surface portion of second circuit substrate, 42 . . . second circuit electrode, 50 . . . connecting part, 100 . . . circuit connection structure.

1. An adhesive composition for bonding a first circuit member including a first circuit electrode formed on a first circuit substrate and a second circuit member including a second circuit electrode formed on a second circuit substrate, the first circuit electrode and the second circuit electrode being electrically connected, wherein
at least one substrate among the first circuit substrate and the second circuit substrate includes a thermoplastic resin having a glass transition temperature of not more than 200° C., and
the adhesive composition contains core-shell type silicon particles having a core layer and a shell layer provided for coating the core layer.

2. An adhesive composition for bonding a first circuit member including a first circuit electrode formed on a first circuit substrate and a second circuit member including a second circuit electrode formed on a second circuit substrate, the first circuit electrode and the second circuit electrode being electrically connected, wherein
at least one substrate among the first circuit substrate and the second circuit substrate includes at least one selected from the group consisting of polyethylene terephthalate, polycarbonate, polyethylene naphthalate and a cycloolefin polymer, and
the adhesive composition containing core-shell type silicon particles having a core layer and a shell layer provided for coating the core layer.

3. The adhesive composition of claim 1, wherein a glass transition temperature of the core layer of the silicon particles is −130° C. to −20° C.

4. The adhesive composition of claim 2, wherein a glass transition temperature of the core layer of the silicon particles is −130° C. to −20° C.

5. The adhesive composition of claim 1, further comprising a radical polymerizable compound.

6. The adhesive composition of claim 2, further comprising a radical polymerizable compound.

7. The adhesive composition of claim 1, further comprising conductive particles.

8. The adhesive composition of claim 2, further comprising conductive particles.

9. A film-like adhesive obtained by forming the adhesive composition of claim 1 into a film.

10. A film-like adhesive obtained by forming the adhesive composition of claim 2 into a film.

11. An adhesive sheet comprising a base and an adhesive layer consisting of the film-like adhesive of claim 9 formed on the base.

12. An adhesive sheet comprising a base and an adhesive layer consisting of the film-like adhesive of claim 10 formed on the base.

13. A circuit connection structure comprising:
a first circuit member including a first circuit electrode formed on a first circuit substrate;
a second circuit member including a second circuit electrode formed on a second circuit substrate; and
a connecting part interposed between a surface of the first circuit member with the first circuit electrode formed thereon and a surface of the second circuit member with the second circuit electrode thereon, and electrically connecting the first circuit electrode with the second circuit electrode, wherein
at least one substrate among the first circuit substrate and the second circuit substrate includes a thermoplastic resin having a glass transition temperature of not more than 200° C., and
the connecting part comprises a cured product of the adhesive composition of claim 1.

14. The circuit connection structure of claim 13, wherein the thermoplastic resin includes at least one selected from the group consisting of polyethylene terephthalate, polycarbonate, polyethylene naphthalate and a cycloolefin polymer.

15. The circuit connection structure of claim 13, wherein one circuit substrate among the first circuit substrate and the second circuit substrate includes at least one selected from the group consisting of polyethylene terephthalate, polycarbonate, polyethylene naphthalate and a cycloolefin polymer, and
the other circuit substrate includes at least one selected from the group consisting of a polyimide resin, polyethylene terephthalate, polycarbonate, polyethylene naphthalate and a cycloolefin polymer.

16. A circuit connection structure comprising:
a first circuit member including a first circuit electrode formed on a first circuit substrate;
a second circuit member including a second circuit electrode formed on a second circuit substrate; and
a connecting part interposed between a surface of the first circuit member with the first circuit electrode formed thereon and a surface of the second circuit member with the second circuit electrode thereon, and electrically connecting the first circuit electrode with the second circuit electrode, wherein
at least one substrate among the first circuit substrate and the second circuit substrate includes at least one selected from the group consisting of polyethylene terephthalate, polycarbonate, polyethylene naphthalate and a cycloolefin polymer, and
the connecting part comprises a cured product of the adhesive composition of claim 2.

17. The circuit connection structure of claim 16, wherein one circuit substrate among the first circuit substrate and the second circuit substrate includes at least one selected from the group consisting of polyethylene terephthalate, polycarbonate, polyethylene naphthalate and a cycloolefin polymer,
the other circuit substrate including at least one selected from the group consisting of a polyimide resin, polyethylene terephthalate, polycarbonate, polyethylene naphthalate and a cycloolefin polymer.

18. A method for connecting circuit members for connecting a first circuit member including a first circuit electrode formed on a first circuit substrate and a second circuit member including a second circuit electrode formed on a second circuit substrate by interposing the adhesive composition of claim 1 and curing to electrically connect the first circuit electrode and the second circuit electrode, and bond the first circuit member and the second circuit member, wherein
at least one substrate among the first circuit substrate and the second circuit substrate includes a thermoplastic resin having a glass transition temperature of not more than 200° C.

19. A method for connecting circuit members for connecting a first circuit member including a first circuit electrode formed on a first circuit substrate and a second circuit member including a second circuit electrode formed on a second circuit substrate by interposing the adhesive composition of claim 2 and curing to electrically connect the first circuit electrode and the second circuit electrode, and bond the first circuit member and the second circuit member, wherein
at least one substrate among the first circuit substrate and the second circuit substrate includes at least one selected from the group consisting of polyethylene terephthalate, polycarbonate, polyethylene naphthalate and a cycloolefin polymer.

20. A use of the adhesive composition of claim 1 for bonding a first circuit member including a first circuit electrode formed on a first circuit substrate and a second circuit member including a second circuit electrode formed on a second circuit substrate, the first circuit electrode and the second circuit electrode being electrically connected, wherein
at least one substrate among the first circuit substrate and the second circuit substrate includes a thermoplastic resin having a glass transition temperature of not more than 200° C.

21. A use of the adhesive composition of claim 2 for bonding a first circuit member including a first circuit electrode formed on a first circuit substrate and a second circuit member including a second circuit electrode formed on a second circuit substrate, the first circuit electrode and the second circuit electrode being electrically connected, wherein
at least one substrate among the first circuit substrate and the second circuit substrate includes at least one selected from the group consisting of polyethylene terephthalate, polycarbonate, polyethylene naphthalate and a cycloolefin polymer.

22. A use of the film-like adhesive of claim 9 for bonding a first circuit member including a first circuit electrode formed on a first circuit substrate and a second circuit member including a second circuit electrode formed on a second circuit substrate, the first circuit electrode and the second circuit electrode being electrically connected, wherein
at least one substrate among the first circuit substrate and the second circuit substrate includes a thermoplastic resin having a glass transition temperature of not more than 200° C.

23. A use of the film-like adhesive of claim 10 for bonding a first circuit member including a first circuit electrode formed on a first circuit substrate and a second circuit member including a second circuit electrode formed on a second circuit substrate, the first circuit electrode and the second circuit electrode being electrically connected, wherein
at least one substrate among the first circuit substrate and the second circuit substrate includes at least one selected from the group consisting of polyethylene terephthalate, polycarbonate, polyethylene naphthalate and a cycloolefin polymer.

24. A use of the adhesive sheet of claim 11 for bonding a first circuit member including a first circuit electrode formed on a first circuit substrate and a second circuit member including a second circuit electrode formed on a second circuit substrate, the first circuit electrode and the second circuit electrode being electrically connected, wherein
at least one substrate among the first circuit substrate and the second circuit substrate includes a thermoplastic resin having a glass transition temperature of not more than 200° C.

25. A use of the adhesive sheet of claim 12 for bonding a first circuit member including a first circuit electrode formed on a first circuit substrate and a second circuit member including a second circuit electrode formed on a second circuit substrate, the first circuit electrode and the second circuit electrode being electrically connected, wherein
at least one substrate among the first circuit substrate and the second circuit substrate includes at least one selected from the group consisting of polyethylene terephthalate, polycarbonate, polyethylene naphthalate and a cycloolefin polymer.
